(19) United States
(12) Patent Application Publication
(10) Pub. No.: US 2003/0106056 A1
(43) Pub. Date: Jun. 5, 2003

(54) System and method for carriage of program-related information in vertical blanking interval (VBI) of video output signal of program guide-Equipped video equipment

(76) Inventor: Saiprasad V. Naimpally, Langhorne, PA (US)

Correspondence Address: RATNERPRESTIA, P O BOX 980, VALLEY FORGE, PA, 19482-0980, US

(21) Appl. No.: 10/292,090

(22) Filed: Nov. 12, 2002

Related U.S. Application Data
(60) Provisional application No. 60/334,272, filed on Nov. 30, 2001.

(51) Int. Cl. G06F 3/00; H04N 5/445; G06F 13/00; H04N 7/16; H04N 7/00; H04N 11/00

(52) U.S. Cl. 725/40; 725/136; 348/468; 348/461

(57) ABSTRACT

Apparatus that transfers program identifying data of the video signal delivered by video equipment such as satellite and cable set-top boxes accesses program-related information from an electronic program guide or from the received television signal and encodes the information into the VBI of the received video signal before transmitting the signal to a video recorder. Apparatus according to the present invention includes a tuner which receives the video signal and circuitry which receives electronic program guide (EPG) information. The apparatus also includes a processor and an XDS encoder. The processor extracts selected EPG information for the program currently being received and, using the XDS encoder, inserts the selected information into the XDS data area of the received signal.

### CROSS REFERENCE TO RELATED APPLICATION

This application claims the benefit under Title 35 U.S.C. §119(e) of U.S. Provisional Application No. 60/334,272 filed on Nov. 30, 2001, the contents of which are incorporated herein by reference.

### FIELD OF THE INVENTION

The present invention relates to identification of programs on recording media that are accessed by video recorders. More specifically, it relates to devices that are able to incorporate EPG program data into the VBI portion of the video signal delivered to the video recorders.

### DESCRIPTION OF THE PRIOR ART

It is useful to tag recorded programs with program-related information such as program title, description, attributes, channel number, etc. for easy access to it. This applies to removable (e.g. DVD-R, DVD-RAM, VCR tape, audio media) and fixed (e.g. Hard Disk Drive) storage media.

Current methods for doing this include:

(a) manual entry by user

(b) using a connection to a program info database, separate from the video connection, as is done by Personal Video Recorders (PVRs) such as are available from several manufacturers affiliated with TIVO and Replay TV

(c) extracting program information from the extended data services (XDS) portion of the vertical blanking interval (VBI) of an analog television signal.

For stand-alone recorders such as DVD recorders, digital and analog VCRs, etc. (hereinafter generically referred to as video recorders), it is useful to be able to acquire program-related information from the video input signal itself. Method (c) above provides such a method but in current practice, for subscribers to multichannel video systems such as cable and satellite systems, this method, however, is not very effective because cable and satellite systems simply pass-through the XDS data at line 21, field 2 of the VBI that has been inserted by the broadcaster. Therefore, the presence of program information in the XDS segment of line 21 is dependent entirely on whether this data exists in the program feed to the cable or satellite system. It is, therefore, not reliable.

In addition, the XDS data may be incomplete. As defined in the EIA-608-A standard, XDS data may include the current time, a channel identifier, a network identifier as well as information on the program including its title and run time as well as a brief summary. When a network sends programming to its affiliates, it may include the network identifier, program name and summary but typically leaves the other fields of the XDS data empty so that they may be filled in by the affiliate. Thus, even if the XDS data of a received program includes title information, it may not include the time at which the program was broadcast or a channel identifier. Both of these items may be useful for a media directory maintained by a video recorder.

Information such as the title of a program, a summary of the program, and the other information referenced above is beneficial for the user of a video recorder to enable the user to easily and quickly determine the nature of the program(s) recorded on a particular recording medium.

One system for generating a directory for a video tape cassette recorder is disclosed in U.S. Pat. No. 6,091,884 entitled ENHANCED OPERATION OF VIDEO TAPE CASSETTE PLAYERS. The system described in this patent prepares a directory for the programs recorded on a tape by reading the XDS data for the program where it is available. When the XDS data is not available, the system requires that the data be entered manually by the user.

### SUMMARY OF THE INVENTION

The present invention is embodied in apparatus that has access to program-related information and that transfers program identifying data into the VBI of the video signal delivered by video equipment such as satellite and cable television (CATV) set-top boxes.

Apparatus according to one aspect of the present invention includes a tuner which receives the video signal and circuitry which receives electronic program guide (EPG) information. The apparatus also includes a processor and an XDS encoder. The processor extracts from the received EPG data, selected EPG information for the program currently being received, stores the extracted EPG information into a memory, and, using the XDS encoder, inserts the selected information into the XDS data area of the received signal.

Apparatus according to another aspect of the invention includes elements that receive and process a video signal in any one of a number of formats including, but not limited to, a baseband television signal, a component video signal, and a carrier modulated with a television signal. The apparatus also includes a processor and an XDS encoder. As in the first aspect, the processor extracts selected EPG information for the program currently being received and, using the XDS encoder, inserts the selected information into the XDS data area of the analog video signal. Afterward, the analog video signal, along with the EPG data, is transmitted to the video recorder in any one of a number of analog video formats including, but not limited to, a baseband television signal, a component video signal, and a carrier modulated with a television signal.

The EPG data may also be obtained via the Internet via a server that is coupled to an EPG service. The server may provide the EPG data to a processor via an FTP processor.

### BRIEF DESCRIPTION OF THE DRAWINGS

FIG. 1 is a block diagram of a television receiver including an embodiment of the present invention and a video recorder that processes video signals provided by the television receiver.

FIG. 2 is a block diagram of an apparatus according to the present invention which interfaces between a television receiver and a video recorder to insert XDS information into the television signal provided by the receiver before the signal is provided to the recorder.

FIG. 3 is a block diagram of an exemplary system that may be used with the apparatus shown in FIG. 1 or FIG. 2 to obtain EPG information via a global information network.

### DETAILED DESCRIPTION

In video equipment such as satellite or cable set-top boxes (STB's) which provide access to a large number of video/audio programs, an on-screen Electronic Program Guide (EPG) is provided to enable easy browsing, surfing and tuning of programs. Therefore, a desirable function of the STB is to associate a selected video/audio program with its title, brief description, attributes and other information.

Many different sources of EPG data are available. For broadcast and cable television systems in a particular area, program guide information may be obtained from a service such as is provided by StarSight Telecast, Inc. (SST). This service provides EPG data through a signal transmitted by a single television channel (e.g. in the vertical blanking interval (VBI) of the local Public Broadcasting System (PBS) affiliate). The EPG data is processed by a microcomputer in the television receiver to produce an on-screen television guide that provides the viewer with information such as the upcoming television programs on all broadcast and cable channels, program plot summaries, and the name of and time remaining in each program currently being transmitted on each of the broadcast and cable channels. This information is available even if the viewer changes channels or if a commercial is being televised. The SST system is described in U.S. Pat. No. 4,706,121, entitled TV SCHEDULE SYSTEM AND PROCESS; U.S. Pat. No. 4,977,455, entitled SYSTEM AND PROCESS FOR VCR SCHEDULING; and U.S. Pat. No. 5,151,789, entitled SYSTEM AND METHOD FOR AUTOMATIC, UNATTENDED RECORDING OF CABLE TELEVISION PROGRAMS.

In addition to SST, other competing services are currently being offered. For example, each of the existing direct broadcast satellite (DBS) systems offers an EPG service for its own programs. This EPG data may be decoded by circuitry similar to that used to decode the SST EPG except that, for DBS signals, the circuitry may reside in the DBS decoder rather than in the television receiver. Cable television (CATV) systems may also provide EPG data for their programs. This EPG data is typically decoded in the set-top box (STB) provided by the cable company. Recently, the functions of analog and digital television receivers, DBS decoders and cable STB's have been combined into a single device known as an integrated receiver decoder (IRD). This device may combine the EPG data provided from several sources to present a unified EPG display, using a system such as is described in U.S. Pat. No. 5,883,677 entitled, METHOD AND APPARATUS FOR MANAGING MULTIPLE OUTSIDE VIDEO SERVICE PROVIDERS.

Digital television signals transmitted according to the ACTV or MPEG standards may also include EPG data, transmitted in a data program of a multi-program bit-stream. Typically, this EPG data is separated from the video and audio information by a transport decoder and processed for display using the on-screen display processor of the digital television receiver.

The subject invention is embodied in apparatus that transfers textual information from the database (memory) in the set-top box to selected data slots in the VBI of the video signal. The VBI time slot chosen for insertion of this program information data desirably is a slot other than those slated to carry closed caption information, content advisory, and other information which is mandated by government regulation to be carried or passed through by cable or satellite set-top boxes. As described above, the XDS protocol defines time slots for this information. The XDS protocol is described in a standard, EIA-608-A, adopted by the Electronic Industries Association (EIA). An alternative to using the XDS protocol to send the identifying data is to use the Teletext protocol defined by the North American Broadcast Teletext Standard (NABTS). Teletext data is transmitted in a manner similar to XDS data but using a larger number of lines. While XDS uses one line in each frame, Teletext uses 22 lines per frame (11 lines in each field). An exemplary decoder that decodes both XDS and Teletext data is described in U.S. Pat. No. 6,239,843 entitled METHOD AND SYSTEM FOR DECODING DATA IN A SIGNAL. An alternative to both the XDS protocol and the Teletext protocol is to provide the identifying data in dedicated data slots or in a dedicated format that is accepted by both the EPG processor and any device that receives the EPG enhanced video signal.

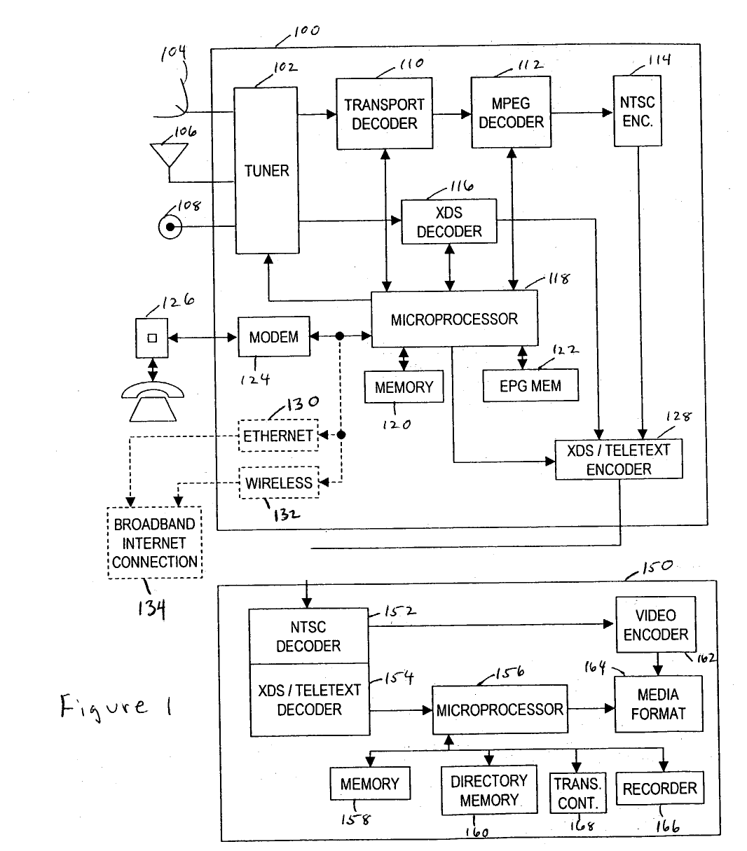

FIG. 1 is a block diagram of a television receiver 100 according to the present invention and a video recorder 150 that extracts the program information which was inserted by the television receiver in order to generate a directory for the programs recorded on the medium (e.g. video tape, DVD etc.). The exemplary television receiver 100 includes a tuner 102 which is coupled to receive digital and analog television signals from a satellite dish 104, a terrestrial antenna 106 and a cable connection 108. If the signal received by the tuner 102 is a digital television signal, it is demodulated into transport packets and applied to a transport decoder 110. If the signal is an analog signal (in this example, an NTSC television signal), it is demodulated to recover a baseband signal which is applied to an XDS decoder 116. The XDS decoder may include, for example, a Z86230 integrated circuit, available from Zilog Inc.

Tuner 102 operates under the control of a micropressor 118. Because microprocessor 118 controls the service (i.e. cable, broadcast or satellite) being used by the tuner 102 as well as the channel to which it is tuned and, in the case of digital television signals, any minor program to be selected from the bit-stream received through the channel, microprocessor 118 can easily identify and extract the EPG data associated with the received program.

As described above, the transport stream of a digital television signal may include EPG data describing all of the programs in the transport stream. Similarly, the XDS portion of the VBI of the analog television signal may include program information for the baseband signal provided by the tuner 102. In the exemplary embodiment of the invention, the transport decoder 110 extracts the EPG data for a specified program from the EPG data received in the digital bit-stream and the XDS decoder 116 extracts the program data from the NTSC video signal. Both the extracted EPG data and the program data are applied to microprocessor 118 which stores it into an EPG memory 122. The microprocessor 118 also includes a memory 120 that may hold, for example, program instructions and may include storage locations used for other functions of the television receiver. Although the EPG memory 122 is shown as being separate from the memory 120, it is contemplated that it may be implemented within the memory 120.

The exemplary microprocessor 118 is also coupled to a modem 124 which is, in turn, coupled to a connection 126 of a public switched telephone network (PSTN). In the exemplary embodiment of the invention, the microprocessor 118 may also receive EPG data from the modem 126, for example, by accessing a web site on a global information network (e.g. the Internet). In this instance, the microprocessor 118 extracts the EPG data from signals obtained through the modem 124 and stores this EPG data into the EPG memory 122. Also in the exemplary embodiment of the invention, the microprocessor 118 may receive EPG data via an Ethernet connection 130 using a network interface card (NIC), operating in accordance with an established protocol, to connect the microprocessor to the broadband Internet connection 134. In the exemplary embodiment, the network interface card may be an Ethernet connection 130 which connects to a broadband modem as the Internet connection 134. Alternatively, it may be a wireless NIC 132 operating according to the 802.11(a), 802.11(b) or 802.11(g) protocols to communicate with a wireless router (not separately shown) which is included within the broadband modem in the broadband Internet connection 134. In yet another embodiment, the wireless NIC 132 may operate according to the Bluetooth protocol and communicate with a narrow-band wireless router in the Internet connection 134. In this embodiment, the Internet connection 134 may be a narrow-band connection.

As described above, the microprocessor 118 may also extract EPG data from a dedicated EPG transmitted with the satellite signal or as a part of the CATV signal. Furthermore, the microprocessor 118 may access EPG data from a broadcast service such as SST.

In addition to separating the data stream containing the EPG data from the digital bit-stream, the transport decoder 110, under control of the microprocessor 118, also extracts selected audio and video programs from the bit-stream and applies the selected programs to an MPEG decoder 112. The exemplary decoder 112 decodes the video and audio signals to produce component video and audio signals which, in the exemplary system, are applied to an NTSC encoder 114. The XDS decoder 116 used in the exemplary embodiment of the invention also provides a baseband NTSC video signal.

Although the exemplary tuner 102 and decoder 112 are shown as providing NTSC baseband signals, it is contemplated that, instead, they may provide component video signals (e.g. RGB; Y, C_{R}, C_{B}; or S-Video). Whether the signals are baseband signals or component video signals, they are applied to an XDS/Teletext encoder 128. The encoder 128, under control of the microprocessor, formats data for insertion into either the XDS portion or the Teletext portion of the luminance, RGB or composite video signal.

In the exemplary embodiment of the invention, the microprocessor 118 inserts program data (e.g. network ID, channel ID, program name, program summary and program length) into the XDS portion of the VBI, if the information is available to the microprocessor and, optionally, if the signal does not already include this information. In the exemplary embodiment of the invention, the microprocessor 118 monitors the XDS information obtained from the NTSC signal to determine if it already contains program title information. If it does, the signal is passed, unmodified by the XDS/Teletext encoder 128. If the NTSC signal does not contain title information, and for all video signals derived from digital television signals, the encoder 128 inserts the title information from the stored EPG database memory 122 and provides the modified signal to the video recorder 150. It is contemplated, however, that the XDS/Teletext encoder 128 may be controlled by the microprocessor 118 to overwrite any title information in the XDS portion of the VBI of the received signal with data from the EPG memory 122, for example, to ensure that the program data is in a consistent format for all signals provided by the television receiver 100.

As described above, the exemplary recorder 150 may be an analog VHS recorder, a digital tape recorder, such as a D-VHS device, a CD-R or CD-RW compact disc recorder, or it may be a DVD recorder. For the sake of simplicity, only the recording circuitry is shown in FIG. 1. It is contemplated, however, that the video recorder 150 may also include playback circuitry (not shown) which accesses and recovers the recorded content from the recording medium.

The exemplary video recorder 150 includes an NTSC decoder 152 which includes an XDS/Teletext decoder 154. It is contemplated that the video recorder may receive video signals in other formats (e.g. RGB, S-VIDEO, etc.) and associated audio signals. Where component video signals are provided, an appropriate decoder may be provided in place of the NTSC decoder 152. The XDS/Teletext decoder 154 would still be used, however, to separate the program data from the VBI of the received video signals.

The exemplary decoder 152 separates the video signal into component parts, in this example, a luminance signal, Y, and two chrominance signals, C_{R} and C_{B}. These signals are applied by the decoder 152 to an encoder 162 which formats the video signal for recording onto the recording medium. This encoder may, for example, encode the video signal using a standard such as the digital video (DV-50) standard or the MPEG standard for recording on a digital video tape or other digital medium. Alternatively, the encoder may format the analog video signals for recording on an analog medium such as a VHS video tape. The encoded data is then formatted for recording by the media formatter 164 and recorded onto the medium by the recorder 166.

In the exemplary embodiment of the invention, a microprocessor 156 in the video recorder 150 controls the video encoder 162, media formatter 164, recorder 166 and, through the transport control 168, the transport mechanism (not shown) of the video recorder. The exemplary microprocessor 156 is coupled to a memory 158 that holds program code and may include additional memory locations for storing data used by the microprocessor in its control operations. In addition, the microprocessor 156 is coupled to a directory memory 160, which may or may not be separate from the memory 158. As described below, the directory memory 160 holds the program data extracted from the received video signals.

In addition to recording video content received from the television receiver 100, the exemplary recorder 150 records and updates a directory—also stored on the recording medium—that lists the recorded content. This directory is stored at a fixed location on the recording medium. When the medium is first inserted into the video recorder 150, the microprocessor 156 retrieves the current directory from the recording medium. Information on each video signal that is received for recording is extracted from the XDS or Teletext portion of the VBI of the received signal and added to the retrieval directory stored in the directory memory 160.

As each new signal is received by the recorder 150, the program data is extracted from the XDS or Teletext portion of its VBI, formatted and stored into the directory memory 160. Where the new content overwrites existing content on the recording medium, the corresponding new program directory data overwrites the existing program data in the directory memory 160. After recording each received program, the contents of the directory memory are stored at the fixed location on the recording medium. For an analog video tape, this location may be at the start of the tape. In this instance, the microprocessor 156 controls the tape transport to rewind the tape to its starting position to store the updated tape directory. When the recording medium is a random-access medium, such as a DVD, the directory on the recording medium may be updated as soon as sufficient information is available to identify the program.

When multiple programs are recorded sequentially or in a single block, the exemplary recorder 150 updates the directory memory 160 with the program data for each program that is being recorded and stores the updated directory on to the recording medium after the last program has been recorded (for tape media) or as sufficient information for each program becomes available (for random-access media).

The advantage of this system is that, whereas some TV channels today do carry channel name, time of day, and other information in the VBI, most do not carry this information and virtually none carry program title information. A cable satellite set-top always has access to this information or may access this information over the Internet. So, barring conditions such as unavailability of VBI lines due to regulatory reasons, it is always possible for the set-top box to provide the data to the recorder in the VBI.

Although the present invention is described in terms of an NTSC analog video signal using program data transferred in the XDS portion of the VBI or in a Teletext field corresponding to NABTS, it is contemplated that the invention may be practiced using a PAL or SECAM analog video signal which transfers program data using, for example, a World System Teletext (WST) standard signal.

Furthermore, while the present invention describes transmitting a baseband television signal between the television receiver 100 and the video recorder 150, it is contemplated that it may transfer a modulated television signal or an S-Video component television signal in which the VBI information is encoded in the luminance signal.

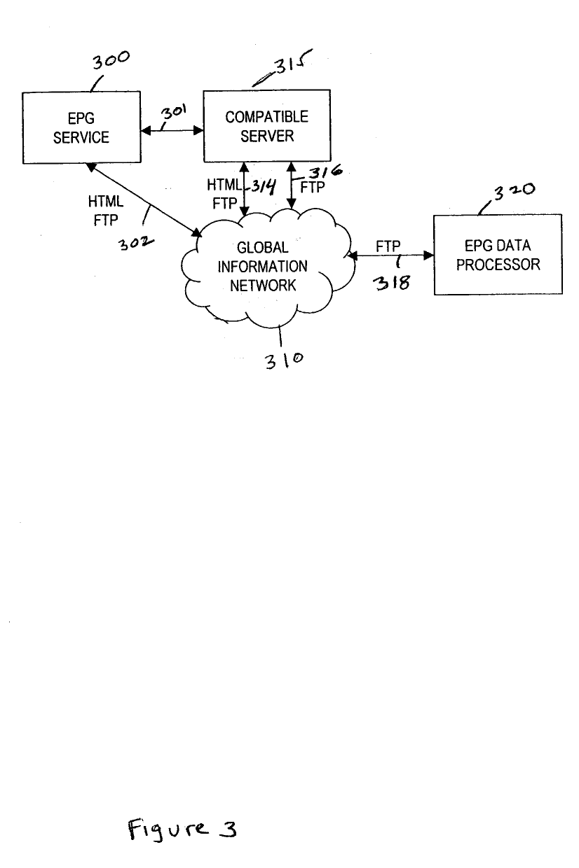

FIG. 3 is a block diagram of an exemplary system that obtains and provides EPG data via a global information network (e.g. the Internet). The system includes a server 315 that is coupled to an EPG service, such as the Tribune Media Zap2it.com service, either by a dedicated connection 301 or via connections 314 and 302 through the Internet 310. The exemplary server 315 may access information from the EPG service in any of a number of different formats including direct database queries (e.g. SQL) or file transfer protocol (FTP) or hypertext markup language transfer protocol (HTTP) via the Internet.

The exemplary server formats the information so that it is compatible with a consumer EPG data processor 320 such as the television receiver 100, described above, or the interface device 200, described below. The server 315 then provides the data to the processor 320, for example, via a FTP processor. It is contemplated that the server 315 may receive information such as a postal code and a cable service and/or satellite service to which the customer subscribes and, based on this information, provide the customer with complete television listings. These listings include the service, channel number, program title, program start time, duration and a brief summary of the program. The EPG data processor 320, for example the microprocessor 118, shown in FIG. 1, may store this information in a local database (e.g. EPG memory 122) and access the data as appropriate for the signal being received by the tuner 102. For a particular program, this data may be accessed, converted to XDS format and encoded with the NTSC signal, as described above. The server 315 may, for example, be maintained by the manufacturer of the television receiver 100 or the interface device 200 (described below) to provide the EPG data in a format known to the EPG data processor of the receiver 100 or device 200.

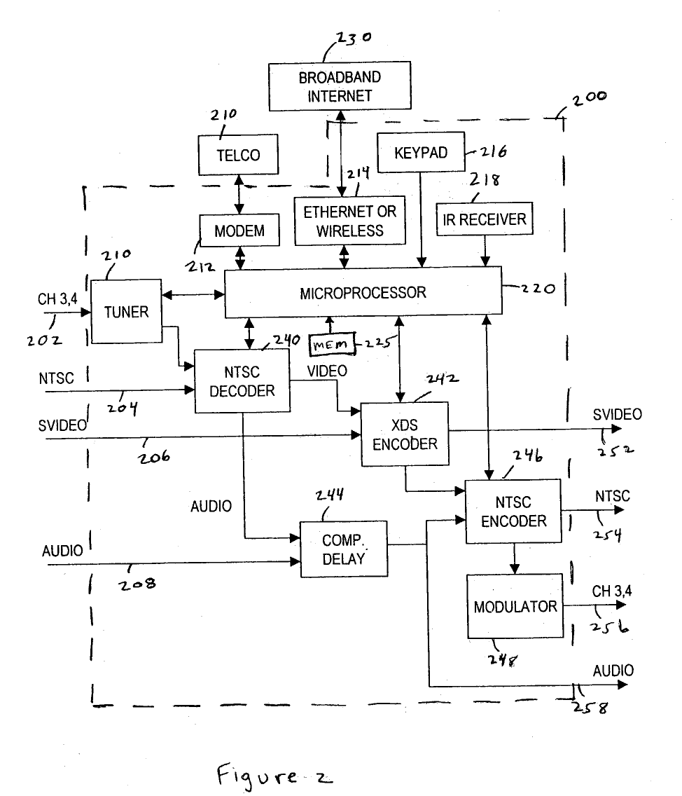

A second exemplary embodiment is shown in FIG. 2 which is a block diagram of an interface device 200 that can be connected to sources of video signals, audio signals, and of EPG data on the one hand and to a video recorder on the other hand. A memory 225 stores the EPG data. Video signals can be obtained, for example, through tuner 210 over channels 3 or 4, from a STB or VCR tuner. Alternatively, they can be obtained as NTSC baseband signals via line 204. Regardless of how the NTSC signals are received, they are transmitted to an NTSC decoder 240 which separates the video signal from the audio signal. The video signal is transmitted to an XDS encoder 242 and the audio signal is sent to NTSC encoder 246 via optional compensating delay 244. The purpose of compensating delay 244 is to delay the audio portion of the signal in case the video portion of the signal is delayed during its processing in the XDS encoder 242 by an amount of time sufficient to desynchronize the audio and video portions of the program.

Under the control of microprocessor 220, NTSC decoder 240 may also separate the video signal into its component parts, a luminance signal, Y, and two chrominance signals, C_{R} and C_{B}. From NTSC decoder 240, the component parts of the video signal are transmitted to XDS encoder 242, which, under control of microprocessor 220, formats the signal to receive the EPG data by adding XDS data to the luminance component.

Alternatively, an S-Video signal, which is a video signal already reduced to its component parts (luminance signal, Y, and two chrominance signals, C_{R} and C_{B}) may be supplied directly over line 206 to XDS encoder 242 which, as described above, formats the signal to receive the EPG data by adding the XDS data to the luminance component. If the interface device uses S-Video as the source of video signals, separate audio signals are provided to the interface device over line 208 to NTSC encoder 246 through optional compensating delay 244. As was the case with the transmission of an NTSC signal along path 204, the transmission of audio signals along path 208 is passed through compensating delay 244 in case the S-Video signal is significantly delayed during its processing in the XDS encoder 242.

Simultaneously with the receipt of video and audio signals, the exemplary microprocessor obtains EPG data from a broadband Internet connection 230, for example, through an Ethernet or wireless connection 214. This connection does not require a browser. Instead, microprocessor 220 is programmed to access the EPG data, using a fixed protocol, for example, file transfer protocol (FTP), from a specific predetermined location on the Internet. Alternatively, microprocessor 220 can obtain the EPG data from a telephone dial-up connection 210 through modem 212 also using FTP.

In the exemplary embodiment of the invention, the interface device 200 includes an infrared (IR) receiver 218 and a keypad 216. Each of these devices may have two functions in the exemplary embodiment of the invention. A first function is to receive commands for the interface device 200, for example, a command for the micropressor 220 to access EPG data from the Internet. A second function is to eavesdrop on the IR commands being sent to the STB or other television receiver which is providing the input video signals to the device 200. By monitoring the IR commands sent to this STB or receiver, the interface device knows the service and channel for the signal that is being received and, using this information, it can automatically access the relevant data from the EPG to insert into the XDS data for the video signal.

After XDS encoder 242 adds the XDS data to the video signal either from NTSC decoder 240 or from the S-Video signal 206 it transmits the XDS-enhanced signal to NTSC encoder 246. From NTSC encoder, the combined signal is transmitted over line 254 to the NTSC input of the video recorder (not shown). Alternatively, the EPG encoded S-Video signal may be transmitted directly from XDS encoder 242 to the S-Video input 252 of the VCR recorder, or DVD player, along with audio signal 258. Finally, the EPG encoded signal may be transmitted from NTSC encoder 246 to a modulator 248 so that it can be retransmitted as a modulated signal on channels 3 or 4 to the video recorder.

As shown, interface device 200 can obtain video signals from channels 3 or 4, from a source of NTSC signals, or from a source of S-Video signals. The interface device 200 can provide the video signals to the video recorder over channels 3 or 4, as NTSC signals, or as S-Video signals. As further shown, interface device 200 can obtain the video signals in any of the described formats and output the video signals to the video recorder in any of the described formats. Accordingly, for example, and not by way of limitation, a video signal received as an NTSC signal over line 204 can be output to the video recorder as an NTSC signal over line 254 or can be output in an S-Video format over line 252.

Alternatively, the embodiment shown in FIG. 2 can be modified so that it does not obtain and transmit S-Video signals along line 206 or output S-Video signals along line 252. In such a case, the embodiment shown in FIG. 2 may be modified by eliminating NTSC 240 and NTSC encoder 246. In such an embodiment, the interface device 200 would only receive, encode, and retransmit NTSC signals from line 204, through XDS encoder 242, to the video recorder along line 254.

As another alternative, the video signal entering the interface device 200 along line 206 may be a component video signal other than luminance and chrominance signals. The video signal may be, for example, RGB signals. In such an alternative, XDS encoder 242 will insert the EPG data into the XDS portion of the particular component most able to carry the EPG data.

Although the invention has been described in terms of exemplary embodiments, it is contemplated that it may be practiced as described above with variations within the scope of the appended claims.

What is claimed:

1. An electronic program guide (EPG) data processor for a video signal, said video signal having a vertical blanking interval (VBI) and digital data slots defined in the VBI, the processor comprising:
a receiver for receiving EPG data from a supplier of EPG data and for receiving a video signal from a video signal supplier;
a memory coupled to the receiver for storing the EPG data related to the video signal; and
an encoder coupled to the memory for inserting the stored EPG data into the digital data slots defined in the video signal.

2. The EPG data processor in claim 1, further including means for receiving the EPG data via a broadband connection to a global information network.

3. The EPG data processor in claim 1, further including means for receiving the EPG data via a narrowband connection to a global information network.

4. The EPG data processor in claim 1, further including a tuner for receiving the EPG data from a predetermined channel provided by the video signal supplier.

5. The EPG data processor in claim 4, further including a processor configured to decode the EPG data from the VBI of a television signal carried on the predetermined channel.

6. The EPG data processor in claim 1, wherein the digital data slots are defined by one of an extended data services (XDS) portion and a teletext portion within the VBI.

7. The EPG data processor in claim 1, wherein the receiver receives the video signal as a digital video signal, the digital video signal including at least one video program and the EPG data; and
wherein the receiver further comprises circuitry for converting the at least one video program into a different format and for transmitting the different formatted program to the encoder.

8. The EPG data processor in claim 7, wherein the different formatted program is formatted as an NTSC signal having digital data slots defined in the VBI and the stored EPG data is inserted into the digital data slots of the NTSC signal.

9. The EPG data processor in claim 8, wherein the digital data slots comprise an XDS portion within the VBI.

10. The EPG data processor in claim 7, wherein the circuitry converts the at least one video program into component video signals, said component video signals having a VBI and digital data slots defined in the VBI and the stored EPG data is inserted into the digital data slots portion of the at least one component signal of the component video signals.

11. The EPG data processor in claim 10, wherein the digital data slots comprise an XDS portion within the VBI and the stored EPG data is inserted into the XDS portion of the at least one component video signal.

12. The EPG data processor in claim 10, wherein the component video signals include a luminance component and a chrominance component and wherein the stored EPG data is inserted in the XDS portion of the luminance component.

13. The EPG data processor in claim 1, wherein the received EPG data includes data for at least two programs and the receiver includes circuitry to retrieve specific EPG data for at least one of said at least two programs.

14. The EPG data processor in claim 1, wherein the receiver receives an NTSC signal from the video signal supplier, the receiver further comprising circuitry for converting the NTSC signal into component video signals, the component video signals including a luminance component signal having a VBI and an XDS portion within the VBI, wherein the encoder receives the component video signals and the stored EPG data and inserts the stored EPG data into the XDS portion of the luminance signal.

15. The EPG data processor in claim 1, wherein:
the receiver receives a component video signal including a luminance component and a chrominance component signal from the video signal supplier, said luminance component video signal having a VBI and an XDS portion of the VBI;
the encoder receives the component video signals and the stored EPG data and inserts the stored EPG data into the XDS portion to form XDS-enhanced video signals.

16. The EPG data processor in claim 15, wherein the receiver further comprises circuitry for converting the XDS-enhanced video signals into an NTSC format.

17. An electronic program guide (EPG) data processor for a video signal, said video signal having a vertical blanking interval (VBI) and digital data slots defined in the VBI, the processor comprising:
a receiver for receiving EPG data from a supplier of EPG data and for receiving a video signal from a video signal supplier, wherein the video signal received by the receiver is an analog video signal as one of a baseband television signal, a component video signal, and a carrier modulated with a television signal;
a memory coupled to the receiver for storing the EPG data related to the video signal; and
an encoder coupled to the memory for inserting the stored EPG data into the digital data slots defined in the video signal to provide an EPG enhanced video signal, wherein the EPG enhanced video signal is one of a baseband television signal, a component video signal, and a carrier modulated with a television signal.

18. The EPG data processor of claim 17, wherein the receiver includes circuitry to identify the program being received.

19. The EPG data processor of claim 17, wherein the component video signals include a luminance component and a chrominance component and EPG data is inserted in the XDS portion of the luminance component.

20. The EPG data processor of claim 19, wherein the received EPG data includes data for at least two programs and the receiver includes circuitry to retrieve specific EPG data for at least one of the at least two programs.

21. The EPG data processor of claim 20, further including circuitry for inserting the EPG data for the program into the XDS portion of the luminance component to provide an EPG enhanced luminance component to provide an EPG enhanced luminance component.

22. The EPG data processor of claim 21, wherein the chrominance and EPG enhanced luminance component video signals are provided as respective output signals of the processor.

23. The EPG data processor of claim 22, further including means to convert the chrominance and EPG enhanced luminance component video signals into an NTSC formatted signal and for providing the NTSC formatted signal as a further output signal.

24. The EPG data processor of claim 23, further including a modulator for modulating a carrier with an NTSC signal and for providing the modulated signal as a yet further output signal.

25. The EPG data processor of claim 24, wherein the received signal further includes an NTSC signal and the EPG data processor further includes means for separating the received NTSC signal into the luminance component signal and the chrominance component signal.

26. The EPG data processor of claim 25, wherein the received signal further includes a carrier modulated with a television signal and the EPG data processor further includes a demodulator to recover the modulated signal to provide the NTSC signal.
